(19) United States
(12) Patent Application Publication
(10) Pub. No.: US 2008/0206550 A1
(43) Pub. Date: Aug. 28, 2008

(54) HYDROPHOBIC SURFACE

(76) Inventor: Michael Jeremiah Borlner, Blacksburg, VA (US)

Correspondence Address: SHERR & NOURSE, PLLC, 620 HERNDON PARKWAY, SUITE 200, HERNDON, VA, 20170, US

(21) Appl. No.: 12/037,518

(22) Filed: Feb. 26, 2008

Related U.S. Application Data
(60) Provisional application No. 60/891,709, filed on Feb. 26, 2007.

(51) Int. Cl. B32B 5/16; B05D 1/36; B05D 5/02

(52) U.S. Cl. 428/323; 427/265; 977/773; 977/890

(57) ABSTRACT

An apparatus (and a method of making the apparatus) that includes a hydrophobic surface layer (e.g. ultra-hydrophobic surfaces and superhydrophobic surfaces). The hydrophobic surface layer has a morphology due to non-uniformly distributed nano-particles in a nano-particle layer(s). The nano-particle layer(s) are bonded to a linking agent layer(s). A hydrophobic surface layer may be formed over a non-uniform nano-particle layer(s), which allows the hydrophobic layer to have a fine roughness (i.e. morphology) with relatively strong water repellency characteristics. Since at least one of the nano-particle layer(s), the cross linking layer(s), and the hydrophobic surface layer may be formed by a self-assembly method, a hydrophobic surface may be formed in a practical and/or cost effective manner to allow for implementation in a variety of applications.

The present application claims priority to U.S. Provisional Patent Application No. 60/891,709 (filed Feb. 26, 2007), which is hereby incorporated by reference in its entirety.

### BACKGROUND

Hydrophobic surfaces (e.g. ultra-hydrophobic surfaces and superhydrophobic surfaces) are used in many technological applications. One characteristic of hydrophobic surfaces is that they are repellent to water. For example hydrophobic surfaces can reduce and/or minimize frictional drag in water, minimize corrosion of an underlying material, and serve as self-cleaning surfaces. These example applications may be realized by a hydrophobic surface's ability to repel water. Some hydrophobic surfaces (e.g. ultra-hydrophobic surfaces and super hydrophobic surfaces) have surface energy attributes and/or morphology attributes (e.g. fine surface roughness) that provide for relatively strong water repellency. However, adequate morphology attributes are difficult and costly to implement using methods such as chemical vapor deposition, lithography, and chemical erosion techniques (e.g. due to the need for vacuum deposition and/or long processing times). Further, such techniques can be difficult, impractical, and/or impossible to implement on a large scale. Accordingly, the use of such techniques may make the formation of hydrophobic surfaces (e.g. ultra-hydrophobic surfaces and superhydrophobic surfaces) either impractical and/or impossible to implement in some desirable applications.

### SUMMARY

Embodiments relate to an apparatus (and a method of making the apparatus) that includes a hydrophobic surface layer (e.g. ultra-hydrophobic surfaces and superhydrophobic surfaces). The hydrophobic surface layer has a morphology due to non-uniformly distributed nano-particles in a nano-particle layer(s). The nano-particle layer(s) are bonded to a linking agent layer(s). In embodiments, a hydrophobic surface layer is formed over a non-uniform nano-particle layer(s), which allows the hydrophobic layer to have a fine roughness (i.e. morphology) with relatively strong water repellency characteristics. In embodiments, since at least one of the nano-particle layer(s), the cross linking layer(s), and the hydrophobic surface layer is formed by a self-assembly method, a hydrophobic surface may be formed in a practical and/or cost effective manner to allow for implementation in a variety of applications.

For example, since a self-assembly manufacturing method may be implemented in ambient and large-scale conditions, surfaces of aircraft, water vessels, automobiles may be realized in a cost effective manner, in accordance with embodiments. Since some self-assembly methods do not require a vacuum chamber, many practical fabrication limitations may be minimized and/or eliminated, in accordance with embodiments. In embodiments, hydrophobic surfaces that are fabricated using self-assembly technology may have optimal and/or superior hydrophobic attributes.

### DRAWINGS

Example FIG. 1 illustrates a drop of water on a non-hydrophobic surface.

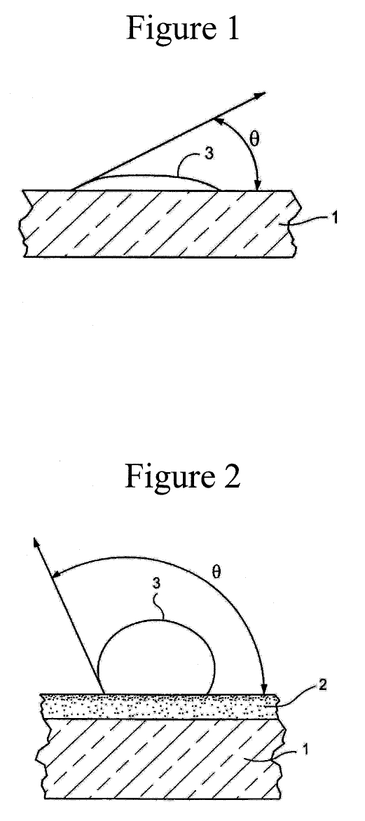

Example FIG. 2 illustrates a drop of water on a hydrophobic surface.

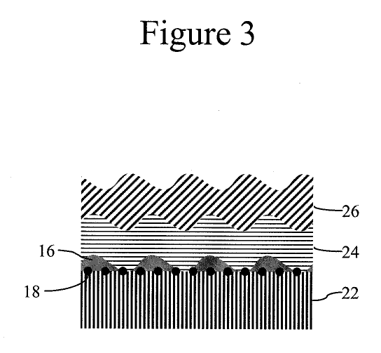

Example FIG. 3 illustrates a hydrophobic surface layer that has a morphology due to non-uniformly distributed nano-particles in an underlying nano-particle layer, in accordance with embodiments.

### DESCRIPTION

Example FIG. 1 illustrates a droplet 3 of liquid (e.g. water) on a non-hydrophobic surface 1. Contact angle θ illustrates the angle formed between a line tangent to the surface of the droplet 3 and the plane of the surface on which the droplet is formed. As illustrated in example FIG. 1, the contact angle θ is relatively small (e.g. an acute angle) for the droplet 3 on a non-hydrophobic surface. As illustrated in FIG. 1, droplet 3 is not relatively repellant to surface 1, as the droplet is shown as being dispersed on surface 1 (also shown by the acute contact angle θ).

Example FIG. 2 illustrates a droplet 3 on a hydrophobic surface 2 (e.g. ultra-hydrophobic surfaces and superhydrophobic surfaces). Hydrophobic surface 2 may be formed over a non-hydrophobic surface 1. As illustrated in FIG. 2, the contact angle θ is relatively large (e.g. obtuse) on a hydrophobic surface compared a non-hydrophobic surface. In other words, the dispersion of droplet 3 on hydrophobic surface 2 is less than the dispersion of droplet 3 on non-hydrophobic surface 1. Accordingly, since the dispersion is less, hydrophobic surface 2 is more water repellent than on a non-hydrophobic surface 1.

In embodiments, hydrophobic surface 2 (e.g. ultra-hydrophobic surfaces and superhydrophobic surfaces) may have both surface energy attributes and morphology attributes. Surface energy attributes may be governed by materials. Examples of a category of low surface energy materials are organic thiols (e.g. dodecanethiol). In theory, the maximum contact angle θ that may be achieved by minimizing surface energy through material choice is 120 degrees. In order to have hydrophobic surfaces with contact angles greater than 120 degrees, the surface must have morphology attributes. In embodiments, morphology attributes may be a fine roughness on the surface.

Ultra-hydrophobic surfaces and superhydrophobic surfaces may have both relatively strong surface energy attributes and morphology attributes. Ultra-hydrophobic surfaces and/or superhydrophobic surfaces may be defined as having a contact angle greater than 150 degrees. One type of hydrophobic surface is a Wenzel type hydrophobic surface. Another type of hydrophobic surface is a Cassie type hydrophobic surface. Cassie type hydrophobic surfaces may have a contact angle greater than 150 degrees. One of ordinary skill in the art would appreciate other type of hydrophobic surfaces aside from Wenzel type surfaces and Cassie type surfaces.

Accordingly, both ultra-hydrophobic surfaces and superhydrophobic surfaces may have morphology attributes to achieve contact angles greater than the theoretical limit of 120 degrees using only surface energy attributes. Note that the theoretical maximum contact angle is 180 degrees, which would mean that a droplet would have no contact with a surface and therefore there would be no dispersion of water on the surface. Another attribute that may affect the contact angle is gravitational attributes. However, gravitational attributes have a relatively small and/or nominal effect on the contact angle compared to the affects of surface energy attributes and morphology attributes.

Example FIG. 3 illustrates a hydrophobic surface layer 26 that has a morphology due to non-uniformly distributed nano-particles 16, 18 in an underlying nano-particle layer, in accordance with embodiments. In embodiments, the nano-particle layer may be formed by self-assembly. Layer 22 may be a linking agent layer that is substantially flat. Through self-assembly, nano-particles 18 may be come into contact with layer 22 and bond to layer 22 (e.g. bond through covalent and/or electrostatic bonding). Nano-particles 18 may bond to sites of layer 22 (e.g. as a linking agent layer) in a substantially uniform distribution. Nano-particles 16 may be excess nano-particles that did not bond to layer 22. Through covalent and/or electrostatic attraction, non-bonded nano-particles 16 may be formed in clusters. Although these clusters may be substantially evenly distributed over nano-particles 18, the overall distribution of nano-particles 16, 18 are non-uniformly distributed (i.e. the thickness of the nanoparticle layer is non-uniform).

In embodiments, nano-particles may be conductive nano-particles (e.g. silver or gold nano-particles). In embodiments, nano-particles may be non-conductive nano-particles (e.g. ceramic nano-particles).

In embodiments, linking agent layer 24 may be formed over a nano-particle layer (e.g. including nano-particles 16, 18). Since the nano-particles 16, 18 are non-uniformly distributed (e.g. due to clusters 16 of nano-particles), linking agent layer 24 may be formed with a given morphology. In embodiments, when linking agent layer 24 is formed over the non-uniformly distributed nano-particle layer (e.g. including nano-particles 16, 18), at least some of the nano-particles 16, 18 bond to the linking agent layer 24. In embodiments, linking agent layer 24 may assume aspects of the non-uniformity of the underlying non-uniformly distributed nano-particle layer (e.g. including nano-particles 16, 18).

In embodiments, hydrophobic surface layer 26 may be formed over linking agent layer 24 to have a given morphology. Hydrophobic surface layer 26 may have a morphology that reflects aspects of the non-uniformly distributed nano-particles 16, 18 in an underlying nano-particle layer. In embodiments, hydrophobic surface layer 26 may be a low surface energy material. For example, hydrophobic surface layer 26 may be an organic low surface energy thiol. In embodiments, hydrophobic surface layer 26 may include dodecanethiol.

In embodiments, when a nano-particle layer (e.g. including nano-particles 16, 18) is formed, the host surface (e.g. linking agent layer 22) may be oversaturated with nano-particles, such that a portion of the nano-particles bond to the host surface (e.g. nano-particles 18 bond to linking agent layer 22) and the remaining nano-particles form loose clusters of nano-particles (e.g. nano-particles 16). By allowing these loose clusters of nano-particles (e.g. nano-particles 16) to remain on layer 22 when linking agent layer 24 is formed (e.g. by not rinsing layer 22 after bonding of nano-particles 18), linking agent layer 24 may exhibit a desirable morphology. This morphology may be exhibited in an overlying hydrophobic surface layer 26, thus allowing the hydrophobic surface layer 26 to have a relatively high contact angle θ with a droplet of liquid. In embodiments, the non-uniformity of the distribution of nano-particles 16, 18 in a nano-particle layer may attribute to the morphology in an overlying hydrophobic surface layer 26. Accordingly, in embodiments, hydrophobic surface layer have at least one of an ultra-hydrophobic surface and/or a superhydrophobic surface.

Although the embodiments illustrated in FIG. 3 only illustrate one nano-particle layer (e.g. nano-particles 16, 18), embodiments include multiple nano-particle layers bonded to multiple linking agent layers. In embodiments, some nano-particle layers may be non-uniformly distributed, while other nano-particle layers may be substantially uniformly distributed. In embodiments, different nano-particle layers may include different types of nano-particles. In embodiments, combinations different nano-particles and different linking agent materials may yield different non-uniform distributions of nano-particles, which may affect the morphology of a hydrophobic surface layer. Accordingly, in embodiments, morphology of a hydrophobic surface layer may be tailored based on choice of materials in underlying nano-particle layers and/or linking agent layers.

Although the morphology illustrated in example FIG. 3 appears sinusoidal for illustration purposes, the morphology may have alternative roughness shapes (e.g. shapes for Wenzel type surfaces and Cassie type surfaces). For example, the morphology of a hydrophobic surface may be tailored to have relatively wide peaks and relatively narrow valleys or relatively narrow peaks and relatively wide valleys, in accordance with embodiments. In embodiments, combinations of different non-uniform distributions of nano-particles in different nano-particle layers (e.g. by different material choices in different nano-particle layers) may be tailor to achieve desirable morphology attributes. Note that the thicknesses shown in FIG. 3 is shown for illustration purposes and are not drawn to scale.

In embodiments, layer 22 may be a linking agent layer or a base layer that otherwise allows for bonding of nano-particles. Layer 22 may be formed on and/or other layers. Layer 22 may have a variety of attributes.

Nano-particles (e.g. nano-particles 16, 18) may be formed through a self-assembly, in accordance with embodiments. U.S. patent application Ser. No. 10/774,683 (filed Feb. 10, 2004 and titled “RAPIDLY SELF-ASSEMBLED THIN FILMS AND FUNCTIONAL DECALS”) is hereby incorporated by reference in its entirety. U.S. patent application Ser. No. 10/774,683 discloses self-assembly of nano-particles, in accordance with embodiments. In embodiments, the size (i.e. diameter or substantial diameter) of the nano-particles may be less than approximately 1000 nanometer. In embodiments, the size of the nano-particles may be less than approximately 50 nanometers. In embodiments, nano-particles may be gold and/or gold clusters. However, in other embodiments, nano-particles may be other metals (e.g. silver, palladium, copper, or other similar metal) and/or metal clusters. In embodiments, nano-particles may include metals, metal oxides, inorganic materials, organic materials, ceramics, and/or mixtures of different types of materials. In embodiments, nano-particles may be semiconductor materials.

Through self assembly, nano-particles may be substantially uniformally and/or spatially dispersed during deposition to form a self assembled film, in accordance with embodiments. The self assembly of nano-particles may utilize electrostatic and/or covalent bonding of the individual nano-particles to a host layer (e.g. a linking agent material layer and/or a flexible base material). A host layer may be polarized in order to allow for the nano-particles to bond to the host layer, in accordance with embodiments. Since the deposition of the nano-particles may be dependent on individual bonding of the nano-particles to the host layer, a nano-particle material layer may have a thickness that is approximately the diameter of the individual nano-particles. Through a self-assembly deposition method, nano-particles that do not bond to a host layer may be removed, so that a nano-particles material layer is formed that is relatively uniform in thickness and material distribution. In embodiments, a non-uniformly distributed nano-particle layer may be formed by over saturating a host layer with nano-particles (e.g. by not removing non-bonded nano-particles) to form loose clusters of nano-particles over nano-particles that bonded to the host layer.

Linking agent material layer(s) (e.g. linking agent material layer 24) may be a material that is capable of covalently and/or electrostaticly bonding to nano-particles, in accordance with embodiments. U.S. patent application Ser. No. 10/774,683 (which is incorporated by reference above) discloses examples of materials which may be included in linking agent material layer(s). Linking agent material layer(s) may include polymer material. In embodiments, the polymer material may include poly(urethane), poly(etherurethane), poly(esterurethane), poly(urethane)-co-(siloxane), poly(dimethyl-co-methylhydrido-co-3-cyanopropyl, methyl)siloxane, and/or other similar materials. Linking agent material layer(s) may include materials that are polarized, in order for bonding with nano-particles, in accordance with embodiments.

In embodiments, linking agent material layer(s) may include a flexible material, an elastic material, and/or an elastomeric polymer. Accordingly, when nano-particles are bonded to sites of material in a linking agent material layer, then the nano-particle material layer may assume the same elastic, flexible, and/or elastomeric attributes of the host linking agent material layer, in accordance with embodiments. This physical attribute may be attributed by the individual bonding of substantially each nano-particle (of a nano-particle material layer) to a site of the linking agent material layer through either covalent and/or electrostatic bonding. Accordingly, when a linking agent material layer is shrunk, stretched, strained, and/or deformed, bonded nano-particles will move with sites of the linking agent material layer to which they are bonded, thus avoiding any disassociation of the nano-particles from their host during deformation.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
at least one linking agent layer;
at least one nano-particle layer bonded to said at least one linking agent layer, wherein the nano-particle layer comprises a plurality of nano-particles that are non-uniformly distributed; and
a hydrophobic surface layer, wherein the hydrophobic surface layer has a morphology due to the non-uniformly distributed nano-particles in the nano-particle layer.

2. The apparatus of claim 1, wherein at least one of said at least one linking agent layer, said at least one nano-particle layer and said hydrophobic surface layer are formed by self-assembly.

3. The apparatus of claim 1, wherein the hydrophobic surface layer is at least one of an ultra-hydrophobic surface and a superhydrophobic surface.

4. The apparatus of claim 3, wherein the hydrophobic surface layer has a water contact angle greater than 150 degrees.

5. The apparatus of claim 1, wherein the hydrophobic surface layer is at least one of a Cassie surface and a Wenzel surface.

6. The apparatus of claim 1, wherein the hydrophobic surface layer is a relatively low surface energy surface.

7. The apparatus of claim 1, wherein the hydrophobic surface layer comprises a thiol.

8. The apparatus of claim 7, wherein the thiol is an organic low surface energy thiol.

9. The apparatus of claim 8, wherein the thiol is dodecanethiol.

10. The apparatus of claim 1, wherein the hydrophobic surface layer is at least one of covalently and electrostaticly bonded to at least one of said at least one linking agent layer and said at least one nano-particle layer.

11. The apparatus of claim 1, wherein the nano-particles are non-uniformly distributed due to at least a portion of the nano-particles not bonding to said at least one linking agent layer.

12. The apparatus of claim 11, wherein said at least a portion of the nano-particles not bonded to said at least one linking agent layer are clustered together in a plurality of clusters.

13. The apparatus of claim 12, wherein the plurality of clusters are substantially uniformly distributed in the nano-particle layer.

14. The apparatus of claim 11, wherein said at least a portion of the nano-particles not bonded to said at least one linking agent layer are clustered together in a plurality of clusters due to at least one of electrostatic bonding and covalent bonding between said at least a portion of the nano-particles not bonding to said at least one linking agent layer.

15. The apparatus of claim 1, wherein said at least one nano-particle layer is bonded to said at least one linking agent layer by at least one of electrostatic bonding and covalent bonding.

16. The apparatus of claim 1, wherein said at least one nano-particle layer comprises non-conductive nano-particles.

17. The apparatus of claim 1, wherein said at least one nano-particle layer comprises conductive nano-particles.

18. The apparatus of claim 17, wherein said nano-particles comprises at least one of silver nano-particles and gold nano-particles.

19. The apparatus of claim 1, wherein said nano-particles has a diameter less than approximately 1000 nanometers.

20. The apparatus of claim 19, wherein said nano-particles comprises has a diameter less than approximately 50 nanometers.

21. The apparatus of claim 1, wherein:
said at least one linking agent layer is an elastomeric polymer; and
individual particles of said at least one nano-particle layer are bonded to sites of the elastomeric polymer.

22. The apparatus of claim 1, wherein at least one of said at least one nano-particle layer and said at least one linking agent layer is polarized.

23. An method comprising:
forming at least one linking agent layer;
forming at least one nano-particle layer, wherein said at least one nano-particle layer is bonded to said at least one linking agent layer, wherein the nano-particle layer comprises a plurality of nano-particles that are non-uniformly distributed; and
forming a hydrophobic surface layer, wherein the hyrdrophobic surface layer has a roughness due to the non-uniformity distributed nano-particles in the nano-particle layer.

24. The method of claim 23, wherein the hydrophobic surface layer is at least one of an ultra-hydrophobic surface and a superhydrophobic surface.
